(19) United States
(12) Patent Application Publication
(10) Pub. No.: US 2002/0132213 A1
(43) Pub. Date: Sep. 19, 2002

(54) Method and apparatus for acquisition of educational content

(76) Inventors: Charles Alexander Grant, Kensington, CA (US); Robert Andrew Bekes, Berkeley, CA (US); Casey Benton Rogers, Sant Barbara, CA (US); James Madison Scott, El Cerrito, CA (US)

Correspondence Address: HOTMATH. COM INC, ATTN CHARLES GRANT, 18 SUNSET DRIVE, KENSINGTON, CA, 94707, US

(21) Appl. No.: 09/961,046

(22) Filed: Sep. 20, 2001

Related U.S. Application Data
(60) Provisional application No. 60/234,456, filed on Sep. 21, 2000.

(51) Int. Cl. G09B 7/00

(52) U.S. Cl. 434/322

(57) ABSTRACT

Methods and apparatus are provided for acquiring content components from content authors, uploading them onto a server and organizing them to enable future access. The content components are optimized for representing solutions to published text-book problems. A special purpose markup language is used, HM/SL, capable of making up problems, solutions, hints, steps, queries, formulas and figures, describes content components. The process for acquiring content components onto the server consists of the steps of preparing a solution for processing, creating an uploadable ZIP, performing the upload, browsing the solutions via drill-down interface, retrieving various reports, checking the status of these reports, and managing a shared solution message area.

### RELATED APPLICATIONS

This application is related to the co-pending applications of the applicant, filed with the present application and assigned to the assignee of the present application entitled, Method and Apparatus for One-Key Learning with an Automated Tutor, Method for Automating Tutoring for Homework Problems; Method and Apparatus for Delivery of Educational Content; the disclosures of which are hereby incorporated by reference.

### FIELD OF THE INVENTION

The field of the present invention relates to an intelligent web-based tutoring system, whereby educational material can be authored, stored, customized and accessed over the world-wide-web.

### BACKGROUND OF THE INVENTION

High-school and college students are often discouraged from continuing with math and science courses because the material seems too difficult. Many of these students fail to reach their potential for understanding and succeeding in math and math-related studies, because they are not as fortunate as others who have math-talented relatives, friends, or tutors who can help them.

The key advancement over the state of the art of internet tutoring is that the present invention does what the human tutors do for the most part, namely help explain homework problems, and yet we require no human tutors.

The present invention was created by teachers who recognize that all students do not understand every lesson in the class time allotted. The guideline for this invention is that Socratic solutions are the best method of leaning how to solve problems.

This invention was designed for the student in class who needs a little more help understanding how to do the homework. Maybe this student misunderstood something in class, got confused, or simply missed the class. And maybe this student can't come to office hours, and doesn't have a friend or relative available to help right now. And can't afford a tutor.

In recent years we have experienced a change in student attitudes, whereby when a student gets stuck on the homework, the student is much more likely to stop working on it. The student either blames the teacher or simply doesn't care.

The educational content is primarily intended to enhance the self-teaching capabilities of students. As such, it contains hints which are helpful clues for students who don't know how to proceed. Upon selection of the ‘Hint’ button, a suggestion will appear. This suggestion should be sufficient to enable the student to proceed with their own paper and pencil solution Students who don't need a hint may skip it.

Often, more than one of the suggestions may be correct. When a student makes a choice, a response appears. To enhance the learning experience, students can try any or all of the choices and internalize all responses. Some answers suggest that the student proceed on their own. In case the student knows the anwer, he/she can proceed to the next step without answering.

A solution can be restarted by selecting the ‘restart’ button and going back to the beginning. Alternatively, students can step back one step by selecting the ‘back’ button.

At the end of each solution, students are requested to ‘grade’ the solution. This feature enables the collection of important marketing statistics. After grading the solution students are referred to the problem index.

The delivery system can also be used to evaluate existing solutions. Students can start from an existing solution and mark on it the steps defined by the delivery system Before moving to the next step, all possible answers can be examined and compared. This capability further enhances the understanding of the subject matter and improves the capabilities of students to generate solution ideas.

The preferred embodiment of the present invention offers tutorial solutions for many of the homework problems in popular math and science textbooks. We know that EVERY student can use some help with homework from time to time; the kind of help that EXPLAINS in detail how to solve problems, so you can learn to solve others like it.

It is expected that students will use the invension when stuck on a problem, need help, or simply review before an exam.

The present invention also provides added value to parents, who can now have fun working on math problems with their students. Parents don't need to be embarrassed that they don't remember the details of a methodology or a specific solution. Student should no longer suffer from rustiness of their parent.

The tutorial solutions are presented in a way that a paid tutor might. Cognitive scientists believe that tutorial explanation of solutions is the state-of-the-art method for learning math and science.

U.S. Pat. No. 4,793,813 discloses a rapidly responsive, computer-based education system wherein a large central computer is adapted to store and execute educational software and to provide a high speed data output stream of multiplexed data frames, and communicate with a plurality of remotely located, keyboard actuated display terminals. This U.S. Patent advances the state-of-the-art with the introduction of a novel communications method, with which communications are accomplished in the forward channel via a satellite link with reverse channel communications being via one or more dedicated telephone lines.

In contrast to U.S. Pat. No. 4,793,813, the present invention does not introduce a new communications method. Instead, the present invention introduces a new specific method for authoring solutions to given problems.

U.S. Pat. No. 5,727,950 discloses a system and method for interactive, adaptive, and individualized computer-assisted instruction. This invention includes an agent for each student, which adapts to its student and provides individualized guidance to the student and controls to the augmented computer-assisted instructional materials. The instructional materials of this invention are augmented to communicate the student's performance and the material's pedagogical characteristics to the agent and to receive control from the agent. Preferably, the content of the communication between the agent and the materials conforms to specified interface standards so that the agent acts independently of the content of the particular materials. Also preferably, the agent can project using various I/O modalities integrated, engaging, lifelike display persona(e) appropriate to the preferences of its student and appear as a virtual tutor to the student. Finally, preferably this invention is implemented on computers interconnected by a network so that instruction can be delivered to geographically distributed students from geographically distributed servers. An important application of this invention is delivering interactive, adaptive, and individualized homework to students in their homes and other locations.

U.S. Pat. No. 5,727,951 discloses a computer-aided-educational system and method to further a students understanding in a subject through associating the subject's different areas that the student has learned. The subject is divided into line-items and relationship-items, with each relationship-item relating two or more items. The items are separated into learnt and un-learned elements. The invention includes the steps of (1) selecting an unlearned element; (2) generating learning materials for the student to learn the selected element; and (3) assessing the student's learning progress in the selected element. If the assessment on the selected element is satisfactory, then the invention (1) classifies one or more relationship-items to be learned as un-learned elements, with each classified relationship-item relating the selected element with one or more learned elements; and (2) re-classifies the selected element as a learned-element. Then the invention repeats from the step of selecting an un-learned element. The steps can repeat until all the un-learned elements have been learned, and at that point, the student has mastered the subject.

In contrast to both U.S. Pat. Nos. 5,727,950 and 5,727,951, the present invention does not advance the state-of-the-art by introducing a new method for adapting to the level and knowledge of the student. Instead, the present invention assumes a fixed solution path whereby the students are presented with steps, from the first to the last, without regard to their performance. In one embodiment of the present invention, multiple training paths are allowed, which are selectable by the student (rather than the system) based on his/her input of the expertise level he/she possesses.

### SUMMARY OF THE INVENTION

The present invention discloses an apparatus and two methods for authoring solutions to known problems used within tutorials, text-books, articles or other educational materials. The problems are always presented as input to the present invention. The solutions are always authored, using client devices, manually, by means of a word-processing program, and represented within a file using a special language called HotMath Solution Language (HM/SL). The file representing a solution in HM/SL is compiled into an HM/SL data structure, whch can then be downloaded onto a server device through a middleware device.

### BRIEF DESCRIPTION OF THE DRAWINGS

FIG. 1 shows the data structure representing the educational content.

FIG. 2 shows a method for acquiring a content component

FIG. 3 shows is an HTML GUI, called the ‘Solutions Page’.

FIG. 4 shows is an HTML pages that enables removing components.

FIG. 5 shows is an HTML GUI for managing a shared message area.

FIG. 6 shows the life-cycle state diagram of a content component

FIG. 7 shows the design of the HM/(SL pre-compiler and compiler

FIG. 8 shows the design of the CHMElement class

FIG. 9 shows the design of the CHMElementSet class

FIG. 10 shows the design of the CHMProbSet class

FIG. 11 shows the design of the CHMProblem class

FIG. 12 shows the design of the CHMProbStatement class

FIG. 13 shows the design of the CHMQuery class

FIG. 14 shows the design of the CHMStep class

FIG. 15 shows the design of the CHMBatchResultsDlg class

FIG. 16 shows the design of the CHotMathApp class

FIG. 17 shows the design of the CHMSpecialChar class

FIG. 18 shows the design of the CHMCharSet class

FIG. 19 shows the design of the CHMImage class

FIG. 20 shows the design of the CXMLFolderDlg class

FIG. 21 shows the design of the CHMEquation class

FIG. 22 shows the design of the ACTrace class

FIG. 23 shows the design of the CSetNames class

FIG. 24 shows the design of the CAuthor class

FIG. 25 shows the design of the yy_parse class

FIG. 26 shows the design of the yy_scan class

FIG. 27 shows the design of the CBatchCompileDlg class

FIG. 28 shows the design of the CHMBatch class

FIG. 29 shows the design of the CHMFileBatch class

FIG. 30 shows the design of the CHMPathBatch class

### DETAILED DESCRIPTION OF THE PREFERRED EMBODIMENTS

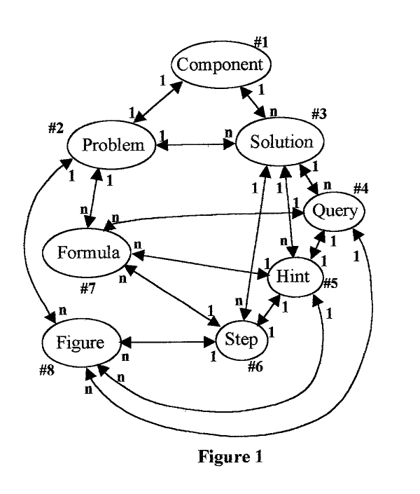

Turning now to FIG. 1, there is shown the data structure, also referred to as the HotMath Solution Language (HM/SL) structure, representing the educational content. The content is represented in the database using XML (extended markup language), which is used as a data description language. The content includes, but not limited to, a collection of components #1, each of which composed of a problem set, whereby each problem may be mapped to one or more solutions #3, and every solution must map to exactly one problem #2. Each problem is composed of, but is not limited to, a collection of mathematical expressions #7 and a collection of images containing information relevant to the problem #8 such as figures, graphs or illustrations. Each solution is composed of, but not limited to, an ordered list of steps #6. Each step is composed of a textual describing a hint #5, a mathematical formula describing the intermediate step #6, a set of possible actions (e.g., for multiple-choice tutorials), and a list of images containing relevant illustrations #8.

The process for acquiring content components onto the Hotmath server consists of the steps of preparing a solution for processing, creating an uploadable ZIP, performing the upload, browsing the solutions via drill-down interface, retrieving various reports, checking the status of these reports, and managing a shared solution message area

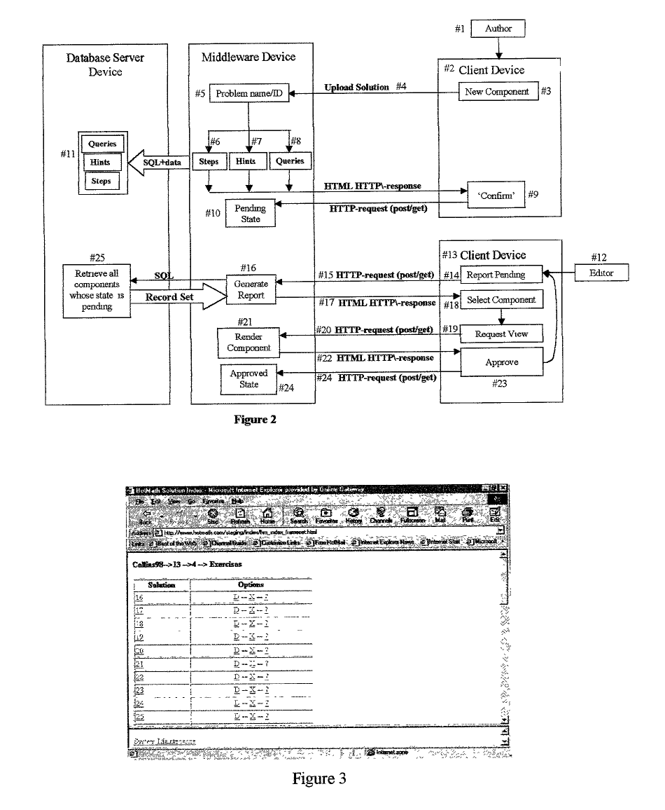

Turning now to FIG. 2, there is shown a process of acquiring an individual content component. The end-user, through the web-browesser, uploads the new solution to the selected solution server. A problem can be described by a book reference, page number and problem number #4. Alternatively, a full description of the problem can be entered #5. A solution is acquired by entering hints #6 and steps #7 iteratively. Upon completion, the end-user, through the web-client, selects the ‘submit’ button #8. As a result, the component is labeled as ‘pending’. Subsequently, the component may or may not be approved #9. In case the component is approved, its label is changed to ‘approved’; otherwise, changed to ‘declined’.

The Hotmath server provides an HTML GUI in which a ‘browse-solutions’ button could be selected to enable performing drill-down. This allows an administrator to use any Internet connected computer to verify each solution. It also allows for viewing the XML used to create the solution and reading and writing comments associated with any solution. Each window in the drill-down pages shows the current position in the hierarchy at top and a link to return to the administrative pages at the bottom.

Turning now to FIG. 3, shown is an HTML GUI, called the ‘Solutions Page’, that is presented as part of browsing through the drill-down hierarchy. The user is presented with three options:

1. D—Delete the selected solution

2. X—View the XML for selected solution

3. ?—View or modify the XML for selected solution

If the user selects the solution link then a new browser window will popup that will contain the solution Tutor. The tutor is shown in a separate window to allow for the drill-down window to remain intact and allow for quick selections of solutions to view.

Turning now to FIG. 5, shown is an HTML GUI for managing a shared message area. This is a ‘group’ area where each solution has a single message, which any administrator can view and edit.

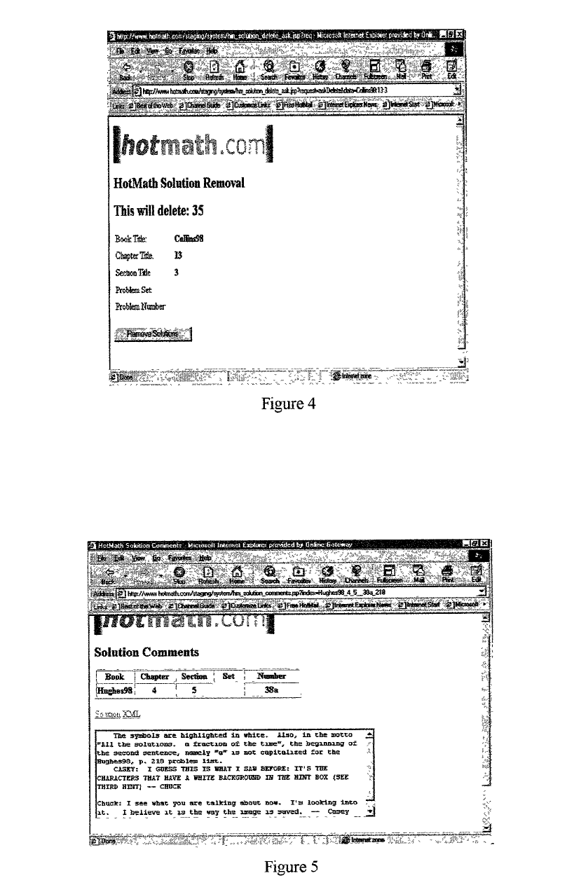

Turning now to FIG. 4, an HTML pages is shown in which a ‘remove-button’ could be selected to enable removing a content component. Once the user clicks the ‘Remove Solutions’ button the solutions are actually removed from the system. If the user selects the ‘Back’ button on the browser NO solutions are deleted. Notice on this dialog that the total number of solutions that would be deleted is displayed as well as the path in the hierarchy.

Solutions are coded using a special-purpose language, called Hotmath Solution Language (HM/SL). HM/SL consists of a set of tags that delineate the various parts of a problem solution, as detailed below. A solution to a problem will be authored using a combination of two MS Windows programs: Microsoft Word and Microsoft Equation Editor. Equation Editor will be used to create mathematical expressions that cannot be written using ordinary text. The integration of Equation editor with MS Word provides for the automatic insertion of the files created with Equation Editor into the MS Word file. MS Word will be used to create the text of the solution. The MS Word file created must be saved as an HTML file, not as an MS Word document, before it can be processed for display on the web.

A problem solution consists of a problem identification followed by a list of items constituting the solution. These items can be hints, questions, or steps. HM/SL defines a method of coding each of these items that is simple and allows figures and equations generated using Equation Editor to be integrated easily into the item Figures and graphs to be inserted in solutions must be GIF files, 300 pixels by 300 pixels square.

To describe components, content authors must use the following HM/SL format. Each solution component begins with a “tag”, which is a symbol that identifies the component. All tags consists of a caret (ˆ ) followed by a letter or letters; tags are not case sensitive. Any exceptions to case insensitivity in HM/SL must be explicitly noted. “ˆ PH” and “ˆ ph” are identical in meaning. A tag should be followed by at least one white-space character. A tag can occur anywhere on a line; but as a matter of style, it is preferred to put each tag on a new line (though it does not need to be in the first column of a line.) Following a tag there can be any text or Equation Editor figures (equations). A solution component is terminated by the tag marking the next component. When necessary, we can define an end tag for each component; but this is avoided whenever possible since it requires more typing for solution authors. In general, parsers are easier to write and more robust in detecting errors when the statements of the language have terminators. The components of a solution must be entered in the order that they will be viewed by the student.

This format is further described in detail in our related submission entitled “Method and Apparatus for Storage and Retrieval of Educational Materials”, hereby incorporated by reference.

Graphs and tables can be created with any software tool that can save them as images which can be imported into a Word file. Most Hotmath solutions authors are using MathGV, a relatively simple yet powerful program that suffices for most purposes. Creating graphs (either 2 dimensional graphs or number-line graphs) may involve the use of additional software packages.

A figure or a graph image is inserted into the steps with the ˆ f tag using the HM/SL solution language. The image file is embedded in the solution file, which is also used to send along any other files related to that figure. Please refer to the HM/SL section for an explanation of how to reference files in solutions.

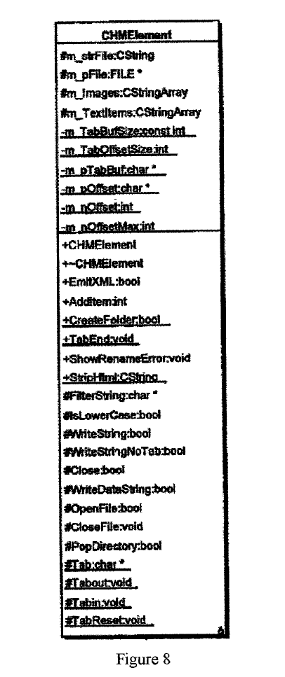

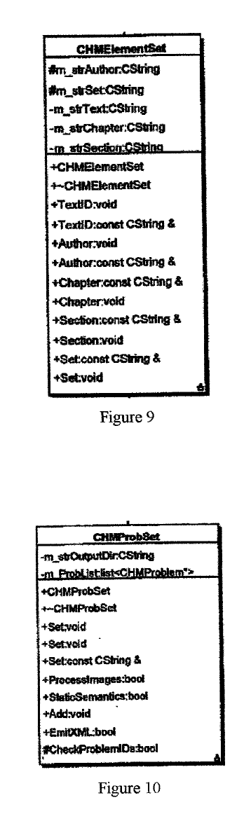

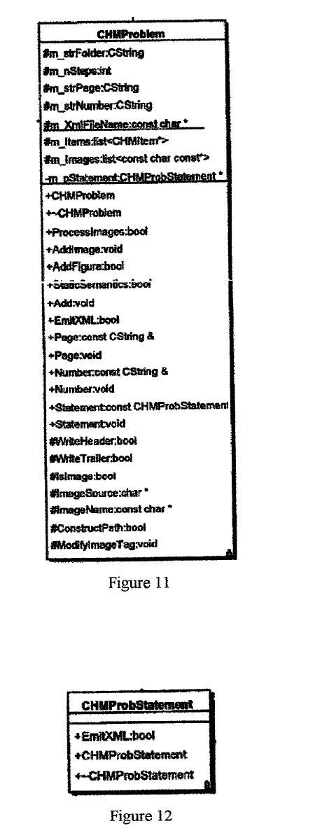

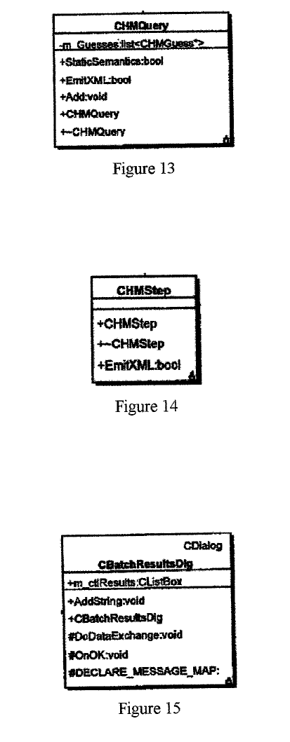

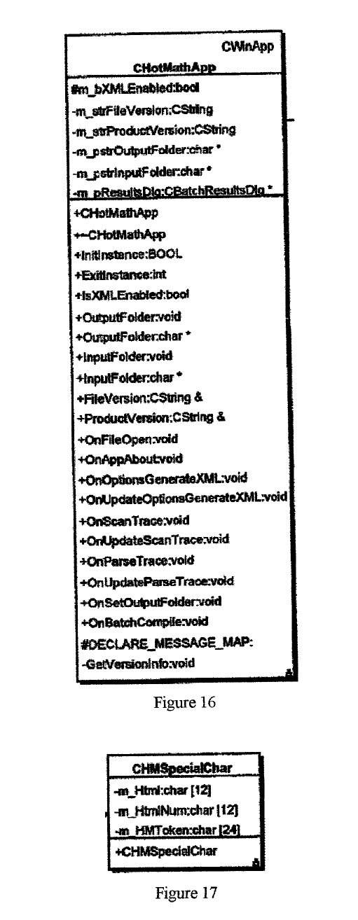

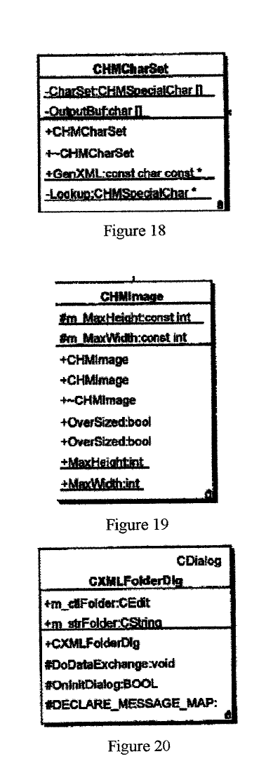

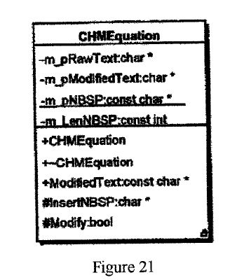

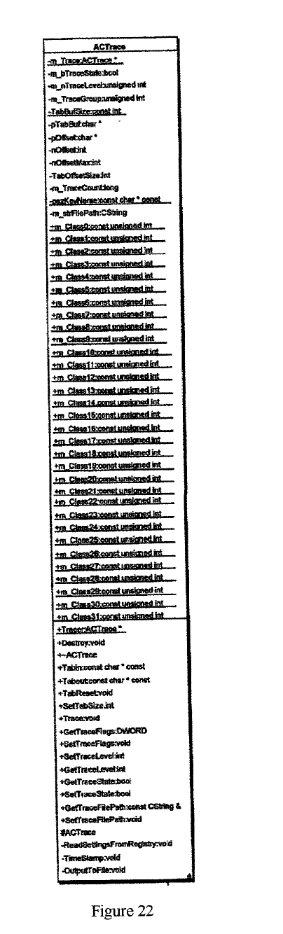

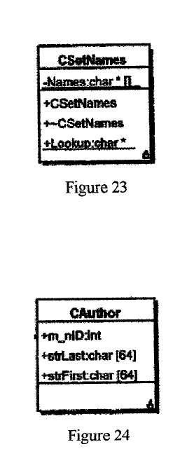

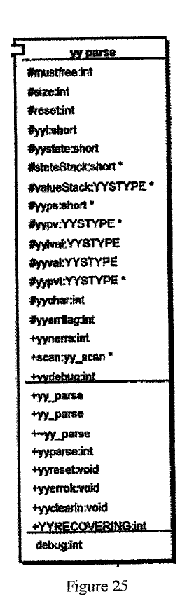

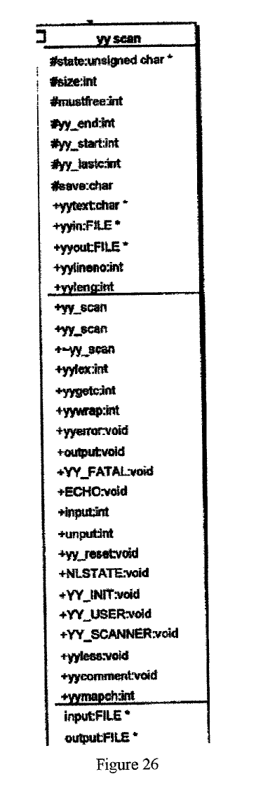

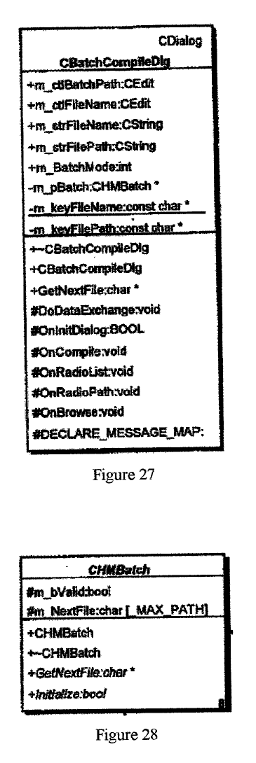

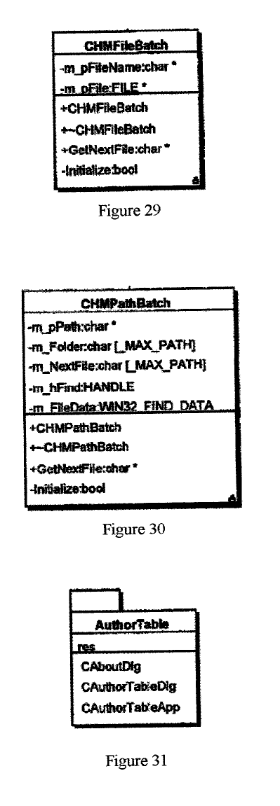

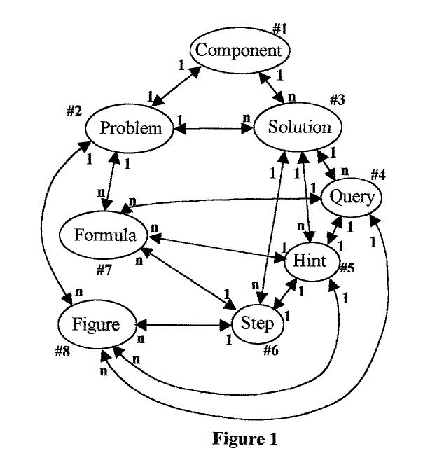

FIG. 7 presents a Unified Modeling Language (UML) description of the apparatus used to automatically process HM/SL files and transport them onto a selected Hotmath solution server. It defines the various objects used as well as the relationships between them FIGS. 5-27 describe the individual classes, their attributes and methods.

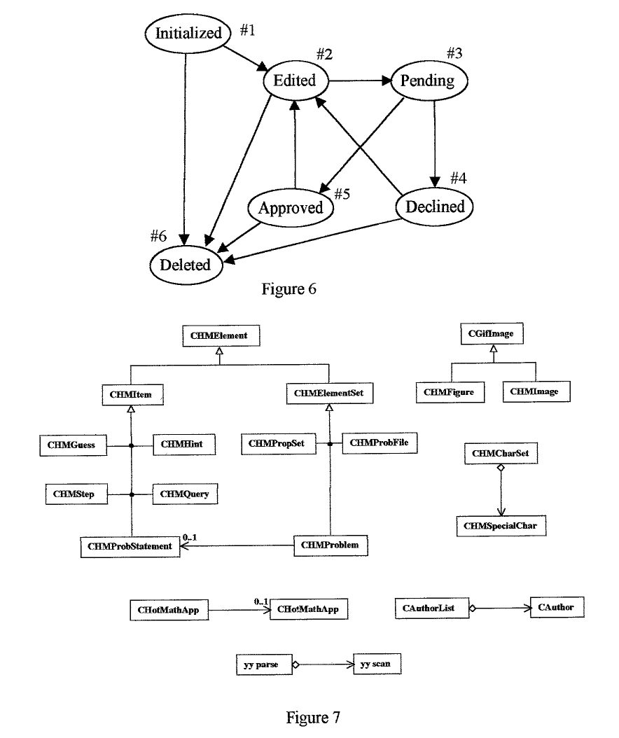

Turning now to FIG. 6, there is shown the life-cycle state diagram of a content component. During construction the component is labeled by the ‘initialized’ state #1. The ‘initialized’ state must transition #2 into the ‘edited’ state #3. The ‘edited’ state must transition into either itself #4 or transition #5 into the ‘pending’ state #6. The ‘pending’ state can be transitioned #7 into the ‘edited’ state #3 or transition #8 into the ‘approved’ state #9, or transition #10 into the ‘declined’ state #11. The approved state can transition #12 into ‘edited’ state, or transition #13 into ‘deleted’ state #14, which is a final-state. The ‘declined’ state can transition into the ‘approved’ state, or transition #15 into the ‘edited’ state, or into transition #16 into the ‘deleted’ state #14. Standard archiving mechanism coupled with undelete procedures can be used to recoved deleted components.

FIG. 2 also illustrates an apparatus for acquiring an individual content component. A web-client (e.g., web-browser) #1 is pointer to the component-authoring URL. The said component-authoring URL arrives at the server which generates a response. The web-browser renders the response, which confirms the update, or reports of a problem. Multiple components can be acquired simultaneously onto the database. To avoid multiple concurrent updates to the same component, the server business logic locks all components, labeled ‘edited’, being updated, to prevent access to any client #8 other than the updating client #1. Once the update is approved and the component is labeled ‘approved’, the updated component is rendered available to all clients.

FIG. 6 also illustrates a method for evaluating components. A component is evaluated only when it is in the said ‘pending’ state. The result of the evaluation may transition the state into the said ‘approved’ state or into the said ‘declined’ state. To begin the evaluation, the evaluator starts with a report listing all components in the ‘pending’ state. Each component in the list can be selected by the evaluator and viewed in isolation from the others. In this case, the selected component is labeled as ‘evaluated’ and a lock may be obtained. Subsequently, the evaluator can label the problem, each hint and each step as either ‘approved’ or ‘declined’. Subsequently, the evaluator can label the entire component as either ‘approved’ or ‘declined’. The evaluator may decide to abandon the final labeling of a component, in which case the component is labeled as ‘pending’, and in case a lock was obntained it must be released. Alternatively, the evaluator may label the entire component as ‘approved’ or ‘declined’ without labeling the problem, nor each individual hint or step; in case a lock was obtained it must be released. Subsequently, the report of ‘pending’ components is updated and presented to the evaluator.

FIG. 2 also describes an apparatus for evaluating components. The editor (or evaluator) points the web-client to the URL requesting the report of ‘pending’ components. The application server translates this URL into SQL queries retrieving all components labeled ‘pending’. The SQL queries are transmitted through standard interface (e.g., ODBC) to the database server. The database server executres the query and returns a record-set. The record-set is converted by the application server into an HTTP-response. The HTTP-response is converted into graphic dispplay by the graphic rendering component of the web-client. The database server and the application server may be hosted by the same physical machine receiving To avoid concurrent updates of multiple components, the server locks the component being evaluated to prevent access to all clients other than the evaluator's client.

The processing of a solution is done using two tools: (1) the solution compiler, which implements the Hotmath solution language and runs on a Windows PC, and (2) the tutor engine, which runs on the server. This program processes the XML files generated by the compiler and displays the solution in a browser.

Solutions to problems are written by solution authors, using Microsoft Word and are saved in files in Word DOC format. In the next step these solution files are converted to HTML using MS Word conversion option. In the next step a solution manager consolidates these files and processes them by the HM/SL compiler. The compiler generates one XML file for each problem solution. In the next step, the solution manager places the XML file, together with any accompanying GIF graphics files, a file folder that is unique to that text book, chapter, section, and problem. In the next step, the solution manager consolidates the files into a single archive file format (e.g., JAR, CAB or ZIP files). In the next step, the manager logs into a server and invokes the uploading option. In the next step the archive (containing the archived files) is uploaded to the server. In the next step, the archived files are extracted from the archive to a temporary working directory determined by the server. In the next step, the content of the XML files is loaded into the database table named SOLUTIONS; the database schema for storing the uploaded solution is given below. In the next step, the associated figure and image files may be renamed to ensure that they have a unique name. In the next step they are copied into a directory accessible through the web.

Following is an example directory structure for two problems stored on the server. The problems directory contains two subdirectories, P1 and P2. The directory P1 contains the file problem.xml, as well as a list of image files img1.gif...img3.gif. The directory P2 contains the file problem.xml, as well as a list of image files dmg1.gif,fdf.gif and img3.jpg.

The collective content of all the uploaded files is stored in a database using a database schema, which includes, but is not limited to:

1. a solutions table containing at most one row for each solution;

2. a comments table containing at most one row for each comment.

3. a book information table containing at most one row for each book;

4. a grades table containing at most one row for each user-problem pair.

TABLE NAME: SOLUTIONS
DESCRIPTION: Used to record a single ‘solution’.

| FIELD | TYPE | USE |
|---|---|---|
| PROBLEMINDEX | INT | PRI KEY (autocreated) |
| PROBLEMNUMBER | TEXT | |
| BOOKTITLE | TEXT | FOR KEY (BOOKINFO) |
| CHAPTERTITLE | | TEXT |
| SECTIONTITLE | TEXT | |
| PROBLEMSET | TEXT | |
| PAGENUMBER | INT | |
| SOLUTIONXML | TEXT | |
| INPUTTER | TEXT | |
| LOADORDER | INT | |
| CREATEDBY | TEXT | |
| CREATEDATE | DATE | |

TABLE NAME: SOLUTIONCOMMENTS
DESCRIPTION: Used to record ongoing comments about a
solution.

| FIELD | TYPE | USE |
|---|---|---|
| PROBLEMINDEX | INT | PRI KEY, FOR |
| | | KEY |
| SOLUTIONCOMMENTS | TEXT | |
| COMMENTDATE | DATE | |

TABLE NAME: BOOKINFO
DESCRIPTION: Used to record a single ‘book’.

| FIELD | TYPE | USE |
|---|---|---|
| TEXTCODE | TEXT | PRI KEY, FOR |
| | | KEY |
| TEXTNAME | TEXT | |
| EDITION | TEXT | |
| PUBLISHER | TEXT | |
| PUBDATE | DATE | |
| AUTHOR | TEXT | |
| ISBN | TEXT | |
| STARTDATE | DATE | |
| ENDDATE | DATE | |
| IMGFILE | TEXT | Name of bitmap |
| | | to use. |

TABLE NAME: SOLUTIONGRADES
DESCRIPTION: Used to store user response to solutions

| FIELD | TYPE | USE |
|---|---|---|
| PROBLEMINDEX | TEXT | PRI KEY, FOR |
| | | KEY |
| USERCODE | TEXT | PRI KEY |
| GRADE | TEXT | |
| COMMENTS | TEXT | |
| GRADEDATE | DATE | |

The HM/SL solution language compiler, referred to as the compiler, is designed and constructed as follows.

1. The input to the said compiler includes, but is not limited to, two source files, HMScan.1 and HMParse.y. HMScan.1. The output of the said compiler includes, but is not limited to, the scanner and parser programs described in the C++ language.

2. To generate the said scanner program, the HMScan.1 file is processed by a lex program The said Lex converts HMScan.1 into HMScan.cpp, a C++ source module that implements a scanner for the HM/SL language.

3. To generate the said parser program, the HMParse.y is processed by a yacc program. The said Yacc converts HMParse.y into HMParse.cpp, a C++ source module that implements a parser for the HM/SL language.

4. The said scanner and parser programs resulting from steps 2, 3 above are incorporated into a MS Windows program called the solution compiler.

5. The said solution compiler receives, as input, one solution HTML file at a time; this file is generated using MS Word HTML exporting option. If the input file is syntactically correct, it creates, as output, a solution parse tree, that can be stored in memory or on disk. The said parse tree is constructed from a hierarchy of C++ classes that is known before the compiler executes, and is fixed during the execution.

6. The output of the compiler is a solution file that describes the following hierarchy. A file contains one or more problem sets. A problem set contains one or more problems. A problem contains one optional problem statement. A problem also contains one or more solutions. There are three categories of solution elements, query, hint and step. A query consists of a question followed by a series of two or more responses, each of which is labeled as either correct or incorrect.

7. A test is performed, called a static semantic check, whereby the said solution file is checked against the said parse tree. This said semantic check verifies whether said solution file satisfies all the semantic rules of the language, as defined by the parse tree, which require that a solution begin with a hint or a query, that every hint or query is followed by a step, that every query has at least two responses, and that the last element is a step.

8. If the said semantic check is successful, an XML file, called the solution XML, is created for each solution. The said solution XML output is generated by calling a function in the C++ class at the root of the parse tree, which in turn calls a similar XML generating function in each node of the parse tree.

To administer the acquisition of educational content, we are currently using the following user profiles:

| User Type | Access |
|---|---|
| Administrator | Complete access to system |
| Solution Manager | Ability to upload, delete and modify solutions. |
| | Ability to traverse solutions via ‘tree’ of solutions. |
| | The tree is based on hierarchy of ‘Book, Chapter, |
| | Section, Problem Set’. |
| User | Only access is through the Hotmath home page. |

The Administrator or Solution Manager is able to get the following reports:

| REPORT | USE |
|---|---|
| Solution Comments | Comments entered by the solution authors and |
| | managers to help build the solutions |
| Solution Grades | Grades the end-user sets after viewing |
| | solutions. |

To achieve the best results, the present invention has set forth the following authoring guidelines:

Keep hints, questions, and explanations brief. We are providing basic solutions rather than exhaustive (or exhausting) ones. In addition, remember that we are not including every exercise. Skip problems that are supposed to be done by calculator, computer, formal proofs (in most cases; some simple ones might fit our format), and the challenge-type problems that typically appear at the end of a problem section. Also skip “open-ended” or creative writing problems.

Follow the style of the textbook. Always browse each section before you prepare the solutions and take special note of the examples. Examples are generally the best guide to the techniques that are supposed to be applied to the exercises. Use terminology and notation consistent with the text's.

There is nothing wrong with solving routine problems with routine techniques (in fact, we should stick to tried and true), but look for reasonable opportunities to inject variety in the solutions.

Avoid “trick” solutions that save steps at the cost of student comprehension.

The right answer to a question should not be predictable by location. Vary your approach. Don't make the right answer always the last (or first) choice.

Include indicative responses to questions, using “Yes”, “No”, “Right”, “Wrong”, etc. We don't want responses to be ambiguous.

Remember that hints are optional as far as the student is concerned and not all students will choose to view them Solutions need to be understandable even if all the hints were omitted. If a hint contains essential information, then it should be a step or part of a step.

The inequality symbols < and > and >= and <= cannot occur in your solution documents unless they are in equation boxes. You may, however, use .LT., .GT., .GE. and .LE. Don't forget the periods. As a shortcut, you may use < and > while writing your solutions, but please remember to do a search and replace to switch them before you submit your document.

The prime symbol for derivatives is often a problem. In regular text, it tends to overlap an italic f, making “f prime” look as though the prime is missing. Insert an extra space to make it look right. In the equation editor, the prime tends to be place too high relative to large parentheses or brackets. In this case, remember that you can highlight it and then use Ctrl+Down arrow to reposition it. (This tip works with other symbols in equation editor, too, with either Ctrl+Up or Ctrl+Down)

Do not mix text and equations on a single line. The alignment problems have not been resolved. This goes for punctuation, too: If an equation is the final step in a series of calculus, put the period inside the equation box, not after it.

Do not insert text inside of equation boxes unless absolutely necessary. Exit back to the word processor when it's time for text. Equation boxes are for equations only.

Use standard punctuation, but there is no need for periods after numerical answers or short responses like “Point-slope formula”. (Remember, semicolons are not permitted.)

Unless there is a specific reason not to, capitalize the first word of a line.

An embodiment of the present invention is as a step within a one-click learning method, for tutoring students. A student at a client device, as is customary in state-of-the-art of web-architectures e.g., a web-browser running on a PC, using Hotmath web-page software (HTML and extensions), may specify a specific problem for which the student wishes a tutorial explanation. The web-page software sends an HTTP-request over the network, e.g., Internet), to a Hotmath server program The Hotmath server program composes an HTML program from the information in the database. The composed program is sent back over the network to the client device. The student then operates the transmitted program, proceeding through the Socratic explanation of the problem in such a way that the student may eventually understand the method of solving the problem. The student may backtrack throught the solution, request hints, consider the preferred queries, and view the steps.

The one-click method is comprised of the steps

a. specifying, through a web-browser pointing to a web-site, one or more problems that are publicly available from sources other than the said web-site, e.g., from text books;

b. authoring a solution, using the present invention, comprising of one or more hints and steps helping students to arrive at other intermediate or final steps for arriving at a solution;

c. storing the solution in a server;

d. retrieving, for the said problems, one or more solutions by one or more authors.

FIGS. 5-27 present self-explanatory diagram of the design of the HM/SL compiler.

We claim:

1. An apparatus for acquiring educational content comprising:
a collection of client devices;
a collection of middleware devices; and
a collection of database server devices.

2. An apparatus as in claim 1 wherein the said client devices comprise:
a file system;
a word-processing component; and
a web-browser component.

3. An apparatus as in claim 2 wherein the said word-processing component is capable of loading, viewing, editing and storing HM/SL files.

4. An apparatus as in claim 3 further comprising an HM/SL compiler capable of compiling said HM/SL files into an HM/SL structure, and subsequently downloading said HM/SL structure onto one of the said middleware devices.

5. An apparatus as in claim 1 wherein the middleware devices comprise:
a collection of content components;
a collection of tutorials;
a collection of user profiles;
a mapping between tutorials and content components;
a mapping between user profiles and tutorials;
a collection of sessions;
a collection of stored procedures; and
a collection of states.

6. An apparatus as in claim 5 wherein the said components are selected from group consisting of problems, group consisting of problem sets, group consisting of problem descriptions, group consisting of problem statements, group consisting of hints, group consisting of guesses, group consisting of queries, group consisting of steps, group consisting of figures and group consisting of images.

7. An apparatus as in claim 4 wherein the HM/SL structure comprises:
a. CHMElement;
b. CHMItem derived from CHMElement;
c. CHMGues derived from CHMItem;
d. CHMHint derived from CHMItem;
e. CHMQuery derived from CHMItem;
f. CHMStep derived from CHMItem;
g. CHMProblemStatement derived from CHMItem;
h. CHMElementSet;
i. CHMProblem derived from CHMElementSet;
j. CHMPropSet derived from CHMElementSet;
k. CHMProbFile derived from CHMElementSet.

8. An apparatus as in claim 5 wherein the user profiles comprise contact information, user roles and permissions.

9. An apparatus as in claim 5 wherein the states are selected from the group consisting of initialized, edited, pending, approved, declined and deleted.

10. An apparatus as in claim 1 wherein the database server devices comprise:
a collection of content components;
a collection of tutorials;
a collection of user profiles;
a mapping between tutorials and content components;
a mapping between user profiles and tutorials;
a collection of sessions; and
a collection of stored procedures.

11. An apparatus as in claim 10 wherein the components are selected from a group consisting of problems, problem sets, problem descriptions, problem statements, hints, guesses, queries, steps, figures and images.

12. An apparatus as in claim 10 wherein the user profiles comprise of contact information, user roles and permissions.

13. An apparatus as in claim 12 wherein the roles comprise of administrator, solutions manager, and user.

14. An apparatus as in claims 10 wherein components further comprise:
a CHMElement,
b. CHMItem derived from CHMElement,
c. CHMGues derived from CHMItem,
d. CHMHint derived from CHMItem,
e. CHMQuery derived from CHMItem,
f. CHMStep derived from CHMItem,
g. CHMProblemStatement derived from CHMItem,
h. CHMElementSet,
i. CHMProblem derived from CHMElementSet,
j. CHMPropSet derived from CHMElementSet,
k. CHMProbFile derived from CHMElementSet.

15. An apparatus as in claim 8 wherein the states transition from initialized to either edited or deleted, from edited to either pending or deleted, from pending to either approved or declined, from declined to deleted, and from approved to deleted.

16. An apparatus as in claim 15 wherein each possible transition is either automatic or may require manual intervention by a human user.

17. An apparatus as in claim 1 wherein the database server comprises:
a. a SOLUTIONS table;
b. a SOLUTIONCOMMENTS table;
c. a BOOKINFO table; and
d. a SOLUTIONGRADES table.

18. An apparatus as in claim 10 further comprising a report generator listing solutions, associated comments, their states and grades provided by users and solution managers evaluating each solution.

19. A method for acquiring educational content including the steps of:
a. posting list of problems to which solutions are needed;
b. selecting at least a problem from the said list;
c. authoring a solution to the said problem;
d. uploading the solution to a server;
e. declaring the state of the solution; and
f. publishing the solution.

20. A method as in claim 19 wherein said problems specify a text book, page number and problem number.

21. A method as in claim 19 step b further allows selecting multiple problems.

22. A method as in claim 19 wherein the said solution comprises a word-processing document.

23. A method as in claim 21 wherein the document contains problem descriptions, problem statements, hints, guesses, queries, steps, figures and images.

24. A method as in claim 19 where the server is a middleware device comprising:
a. authoring content components;
b. authoring collection of tutorials;
c. authoring user profiles;
d. constructing a mapping between tutorials and content components;
e. constructing a mapping between user profiles and tutorials;
f. constructing sessions; and
g. authoring stored procedures.

25. A method as in claim 18 wherein the said states are selected from the group comprising of edited, pending, approved, declined, or deleted.

26. A methods as in claim 24 wherein solution managers can transition the state from edited to either pending or deleted, from pending to either approved or declined, from approved to deleted, and from declined to deleted.

27. A method as in claim 19 wherein uploading a solution is performed by means of an HTTP-Request.

28. A methods as in claim 19 wherein the said uploaded solutions and their assigned states can be reviewed by means of transmitting an HTTP-Request and reviewing the HTTP-Response.

29. A method as in claim 19 wherein the said uploaded solutions can be reviewed by generating reports specifying their authors, states, and grades provided by users evaluating the said uploaded solutions.

30. A one-click method for tutoring students, comprising of the steps of:
a. specifying, through a web-browser pointing to a web-site one or more problems that are publicly available from sources other than the said web-site;
b. authoring one or more solutions for the said problems; and
c. retrieving one or more solutions for the said problems.

31. A method as in claim 30 wherein step b further comprises the steps of:
a. editing an HM/SL file using word-processing means;
b. compiling the HM/SL file on a client device to derive an HM/SL structure; and
c. transmitting the HM/SL structure to a middleware device.

32. A method as in claim 31 wherein the HM/SL structure comprises:
a. CHMElement;
b. CHMItem derived from CHMElement;
c. CHMGues derived from CHMItem;
d. CHMHint derived from CHMItem;
e. CHMQuery derived from CHMItem;
f. CHMStep derived from CHMItem;
g. CHMProblemStatement derived from CHMItem;
h. CHMElementSet;
i. CHMProblem derived from CHMElementSet;
j. CHMPropSet derived from CHMElementSet; and
k. CHMProbFile derived from CHMElementSet.

33. A method as in claim 31 wherein middleware device further comprises a database server.

34. A method as in claim 33 wherein the middleware device translates the HM/SL structure into a format that is stored in a set of relational database tables, including:
a. a SOLUTIONS table;
b. a SOLUTIONCOMMENTS table;
c. a BOOKINFO table; and
d. a SOLUTIONGRADES table.

35. An apparatus as in claim 1 wherein middleware device further comprises a group message board.

36. A method as in claim 30 wherein step ‘a’ further comprises the steps of:
a. browsing the database of content components through a drill-down interface;
b. posting to a group message board messages associated with one or more content components; and
c. browsing a group message board through a message drill-down interface.

37. A method as in claim 30 wherein step ‘c’ further comprises the steps of:
a. retrieving one or more content components through a drill-down interface;
b. posting to a group message board messages associated with one or more content components;
c. browsing a group message board through a message drill-down interface.

38. A content component acquisition method comprising the steps of:
a. preparing a solution for processing;
b. creating an uploadable ZIP;
c. performing the upload;
d. browsing the solutions via drill-down interface;
e. retrieving various reports;
f. checking the status of these reports; and
g. managing a shared solution message area.

39. A method as in claim 38 wherein step ‘g’ further comprises of the steps of:
a. browsing the database of content components through a drill-down interface,
b. posting to a group message board messages associated with one or more content components,
c. browsing a group message board through a message drill-down interface.
